(19) United States
(12) Patent Application Publication
(10) Pub. No.: US 2008/0054017 A1
(43) Pub. Date: Mar. 6, 2008

(54) Liquid Dispensing Apparatus and System

(75) Inventors: Chun Yen Wang, Ormand Beach, FL (US); Hung Hsiang Chen, Ormond Beach, FL (US)

Correspondence Address: MICHAEL P. MAZZA, LLC, 686 CRESCENT BLVD., GLEN ELYN, IL, 60137, US

(73) Assignee: MTN PRODUCTS, INC., Pomona, CA (US)

(21) Appl. No.: 11/468,342

(22) Filed: Aug. 30, 2006

(51) Int. Cl. B67D 5/08

(52) U.S. Cl. 222/64

(57) ABSTRACT

A liquid dispensing system including a renewable source of the liquid, such as a water bottle, in fluid communication with a reservoir contained by a dispensing apparatus such as a water cooler, from which the liquid may be dispensed. A device providing a flow path between the renewable source of the liquid and the reservoir has liquid and air flow paths which are different. Various flow path configurations, using cold and hot water tanks and various sensing devices, may be employed.

### RELATED COPENDING APPLICATIONS

Copending U.S. Ser. No. 11/382,114 filed May 8, 2006 and titled “Bottle Cap And Method Of Use With A Liquid Dispensing Apparatus And System” (“the Bottle Cap Invention”) is hereby incorporated by reference in its entirety into this disclosure, as is copending U.S. Ser. No. ______, filed Aug. ______, 2006 and titled “Bottom Load Water Cooler” (“the Bottom Load Water Cooler Invention”).

### BACKGROUND OF THE INVENTION

The present invention generally relates to the dispensing of liquid from liquid containers such as water bottles. More specifically, the invention is concerned with the air and liquid flowing from the water bottle into the reservoir of a water cooler, for example.

When the water consumer installs a water bottle on a conventional water dispensing appliance, an internal cap plug on the bottle cap is dislodged and seats itself on an upstanding probe. An opening in the probe allows water to flow into the water dispensing appliance, preferably without spilling and without the need to remove the cap and expose the contents of the bottle to contamination. Examples of such dispensing apparatus and systems are disclosed in U.S. Pat. No. 5,289,854 to Baker et al., U.S. Pat. No. 5,232,125 to Adams and U.S. Pat. No. 5,957,316 to Hidding et al., which are each incorporated in their entirety into this disclosure. Conventional probes allow air into the bottle, to prevent lock-up during dispensing, using the liquid flow path. Sometimes, however, conventional probes can lock up dispensing, as air is not permitted to enter the water bottle. Liquid flow rates may not be optimum, either.

The present invention is designed to overcome these problems, while retaining the advantages of current liquid dispensing systems.

### SUMMARY OF THE INVENTION

The present invention provides no-spill water dispensing apparatus and a system. In a particularly preferred embodiment, separate air and water flow paths are provided into and out of the water bottle, respectively. Testing confirms that a hollow probe design with separated air and liquid flow paths provides better flow rates than probes using the single liquid/air flow path approach, as in conventional applications. Thus, the separated air and liquid flow paths probe is believed to provide a more consistent liquid flow, as air may be constantly introduced into the renewable source from a separated path, facilitating pressure balance.

In a preferred embodiment of the invention, a liquid dispensing system includes a renewable source of the liquid, such as a water bottle, in fluid communication with a liquid reservoir(s), such as cold and hot tanks within a water cooler. Liquid moving from the renewable source to the liquid reservoir defines a liquid flow path. An engagement device in fluid communication with the reservoir may be provided, for removably engaging the renewable source in fluid communication. The engagement device houses separate conduits respectively defining a portion of the liquid flow path, and also defining a separate air flow path through the engagement device and into the renewable source. A pump may be provided, in fluid communication with the renewable source of the liquid and with the liquid reservoir. Ambient air from the atmosphere may be allowed to supply air to the air flow path of the engagement device, regulated by a check valve, for example. A device, such as a floating ball contained within a compartment and designed to seat against an air-vent opening in the compartment, may be used to air-tight seal the reservoir against further air entry once liquid in the reservoir has reached a desired level.

A computer such as a PCB and one or more solenoids and electrical temperature sensors disposed in the hot and cold tanks may be used to control and monitor liquid dispensing. One or more sensors may also be used to detect the presence of the renewable source of liquid and/or the level of liquid within the renewable source.

A bottle cap for the renewable source may also be provided. The bottle cap may be a conventional one and/or the one disclosed in U.S. Pat. Nos. 5,289,854 or 5,957,316. Alternatively, the bottle cap used with the present invention may be of the type disclosed in the Bottle Cap Invention, having: (a) a cap body with an outer annular wall sized to sealingly contact a neck of the liquid reservoir, and an inner annular wall with at least one plug gripping formation; and (b) a cap plug having an outer surface with at least one cap gripping formation for engaging a corresponding of the at least one plug gripping formation. The cap body and the cap plug may be physically attached by a tether to ensure that the cap plug does not completely disassociate from the cap during liquid reservoir removal and replacement.

### BRIEF DESCRIPTION OF THE DRAWINGS

The novel features which are characteristic of the invention are set forth in the appended claims. The invention itself, however, together with further objects and attendant advantages thereof, can be better understood by reference to the following description taken in connection with the accompanying drawings, in which:

FIG. 1 is a schematic view of a preferred embodiment of a water dispensing system according to the present invention;

FIG. 2 is an enlarged schematic view of a first circled portion of FIG. 1, illustrating one embodiment for sealing air flow into the top of the cold water tank;

FIG. 3 is an enlarged schematic view of a second circled portion of FIG. 1, illustrating the different air and liquid flow paths;

FIG. 4A is a perspective view showing an embodiment of a water flow device of the present invention;

FIG. 4B is a side cross-sectional view of the device shown in FIG. 4A;

FIG. 4C is a side and bottom perspective view of the device shown in FIG. 4A;

FIGS. 5A-5C are views corresponding to those in FIGS. 4A-4C, respectively, of an alternative preferred embodiment of the water flow device of the present invention;

FIG. 6A is a side and top perspective view of yet another embodiment of the water flow device of the present invention;

FIG. 6B is a sectional view of the water flow device shown in FIG. 6A;

FIG. 7 is a perspective view showing a bottle neck and bottle cap disposed above a skirt and probe prior to engagement; and

FIGS. 8A-8F show alternative embodiments of water dispensing systems according to the present invention.

The components in the drawings are not necessarily to scale, emphasis instead being placed upon clearly illustrating the principles of the present invention. In the drawings, like reference numerals designate corresponding parts throughout the several views.

### DETAILED DESCRIPTION OF THE PREFERRED EMBODIMENTS

Set forth below is a description of what are believed to be the preferred embodiments and/or best examples of the invention claimed. Future and present alternatives and modifications to this preferred embodiment are contemplated. Any alternatives or modifications which make insubstantial changes in function, in purpose, in structure, or in result are intended to be covered by the claims of this patent.

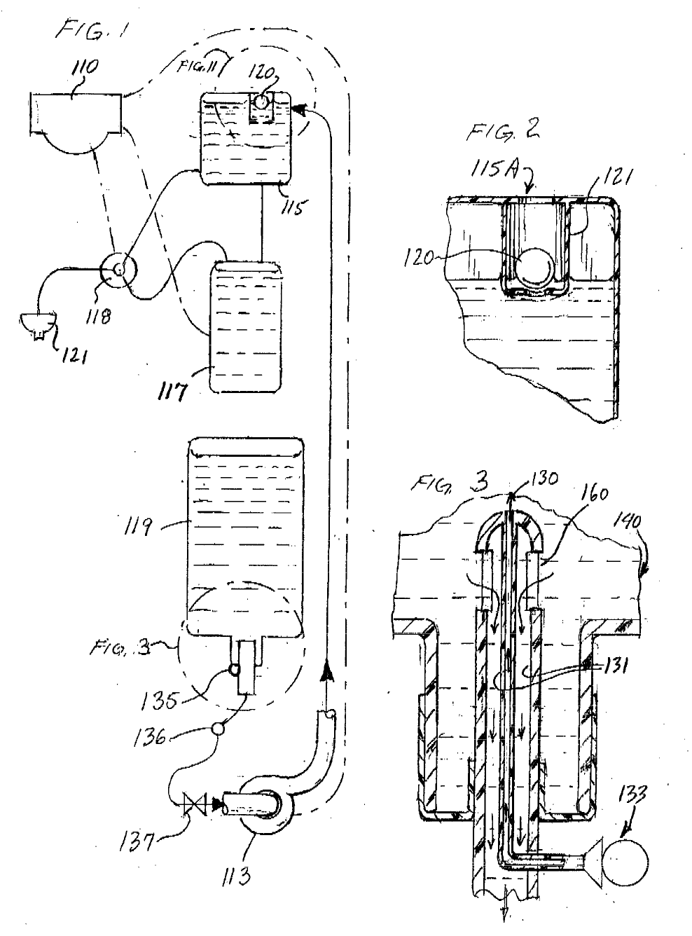

Referring first to FIG. 1, a preferred embodiment of a water dispensing system of the present invention, designated generally as 100, is shown. Dispensing system 100 may be used with water bottles 119 having bottle caps of the type disclosed in the Bottle Cap Invention, or with alternative and/or conventional bottle caps. In dispensing system 100, printed circuit board (PCB) 110 may be provided in (wired or wireless) electrical communication with water pump 113, cold tank 115, hot tank 117, and 3-way solenoid 118. Spout 121 may also be provided in electrical communication with solenoid 118 to permit dispensing.

In operation, when the user first electrically energizes system 100, pump 113 begins pumping water to cold tank 115 and to hydraulically-linked hot tank 117. Referring to FIG. 2, when cold tank 115 is filled to an appropriate level, floating ball 120 contained within enclosure walls 121 floats and seals against sealing area 115A, which may be provided with an O-ring (not shown) for this purpose, resulting in a sealed cold tank. (Prior to ball 120 floating to seal tank 115, as cold tank 115 is filled with water, air within cold tank 115 is permitted to escape out of the top of the tank through opening 115A.) When the tank is full, a sensor may be used to sense the resulting current spike from the water pump, stopping the pump. Now, system 100 is ready to dispense water.

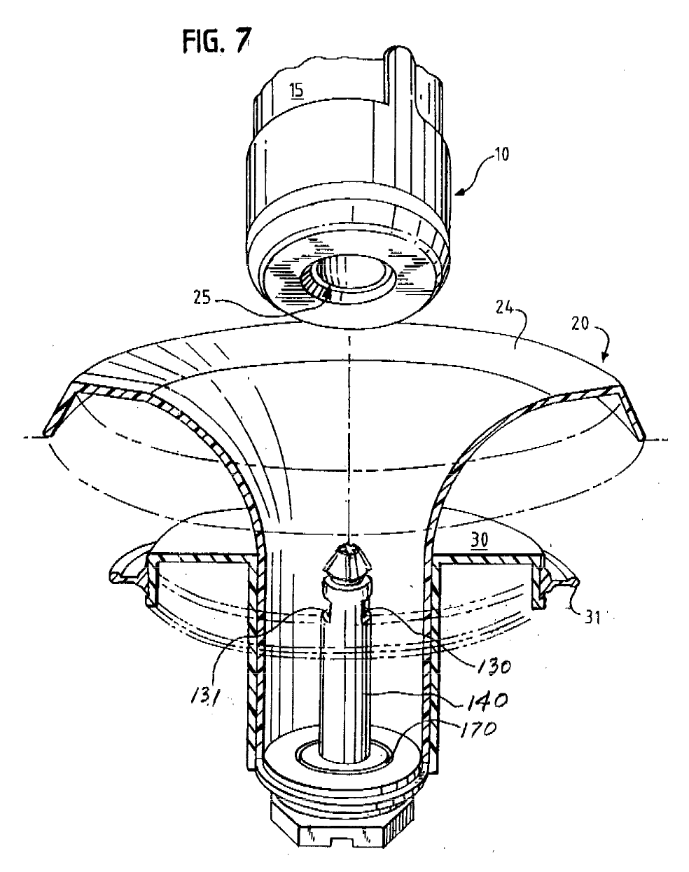

Referring to FIGS. 3-6, each of the alternative water flow devices 140, 240 and 340 shown provide separate flow paths 130 and 131 for air and water, respectively, with flow in the directions indicated by the arrows. During dispensing, water path 131 is defined by water flowing through the neck of water bottle 119, bottle cap 10, hollow skirt 24 and hollow probe 140 (see FIG. 7). Air path 130 is ensured by air flowing from the atmosphere through breathing check valve 133 (preferably positioned close to the dispensing spout, to prevent water drippage) and into bottle 119, thus avoiding air-lock and allowing continued dispensing. (A check valve may also be located on the path to the cold tank to prevent drawing air back into the tank.)

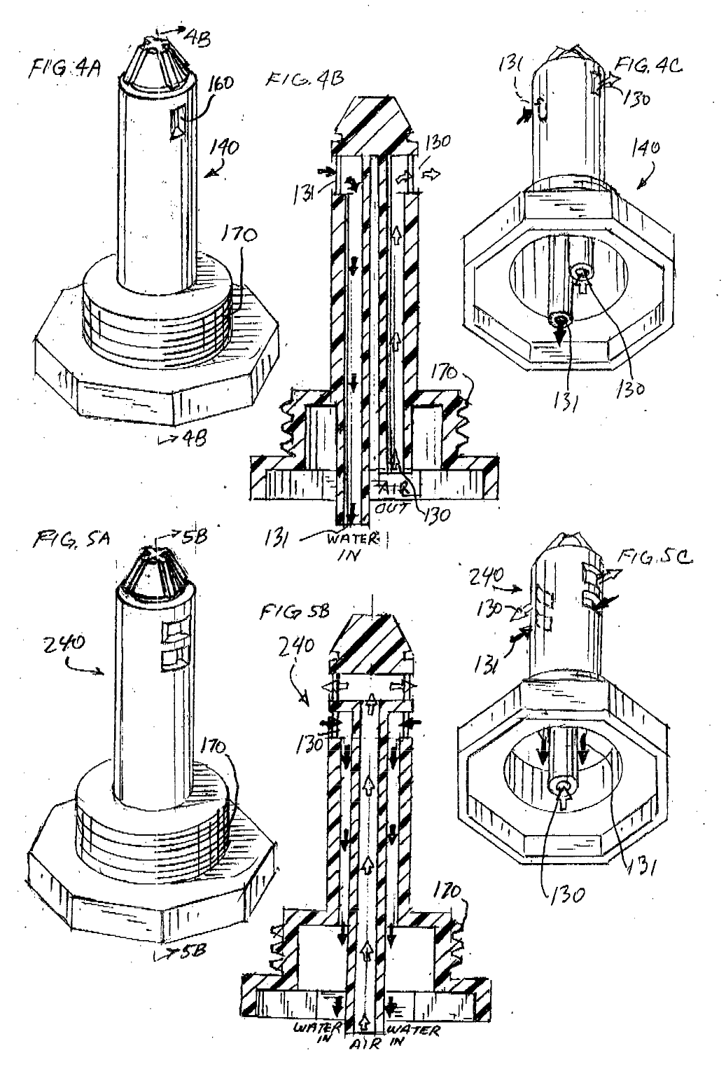

Referring to FIGS. 4A, 5A and 7, threads 170 may be provided, for example, for threaded connection of water flow device 140 to a reservoir or other device (not shown).

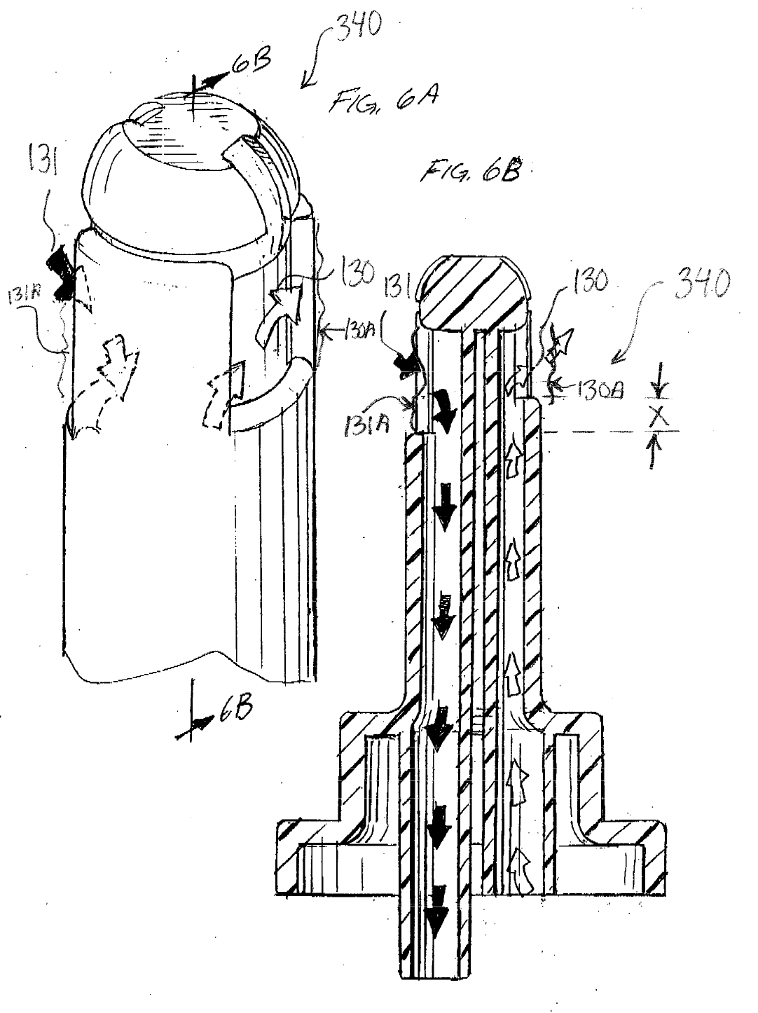

FIGS. 6A-6B show a particularly preferred water flow device 340. It may be seen that the air flow path 130 and water flow path 131 have upper openings 130A and 131A, respectively, which are at different levels. In this preferred embodiment, this height differential “X” (FIG. 6B) may be about 0.2 inches, for example, with the overall height of the water flow device 340 being about 3.5 inches, while the diameter of the air and water flow path tubes may be about 0.4 inches. Because or the pressure difference, it was found that water will tend to pass through the lower opening, while air will tend to pass through the upper opening, creating virtual air-only and water-only paths.

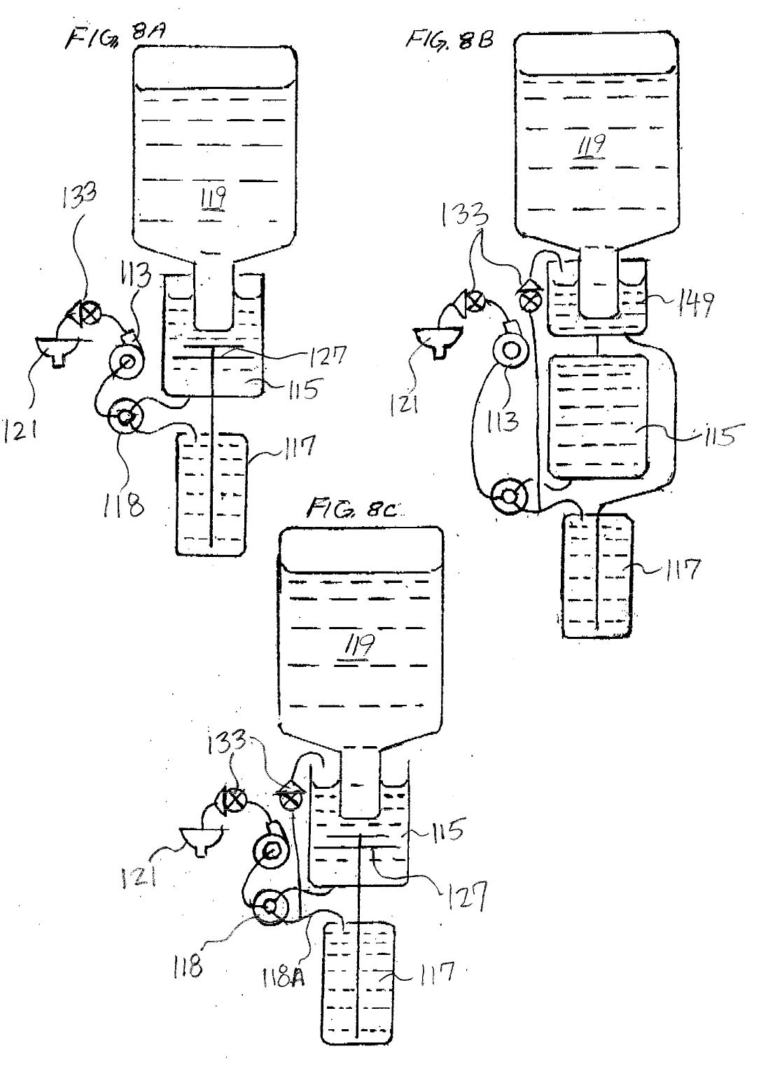

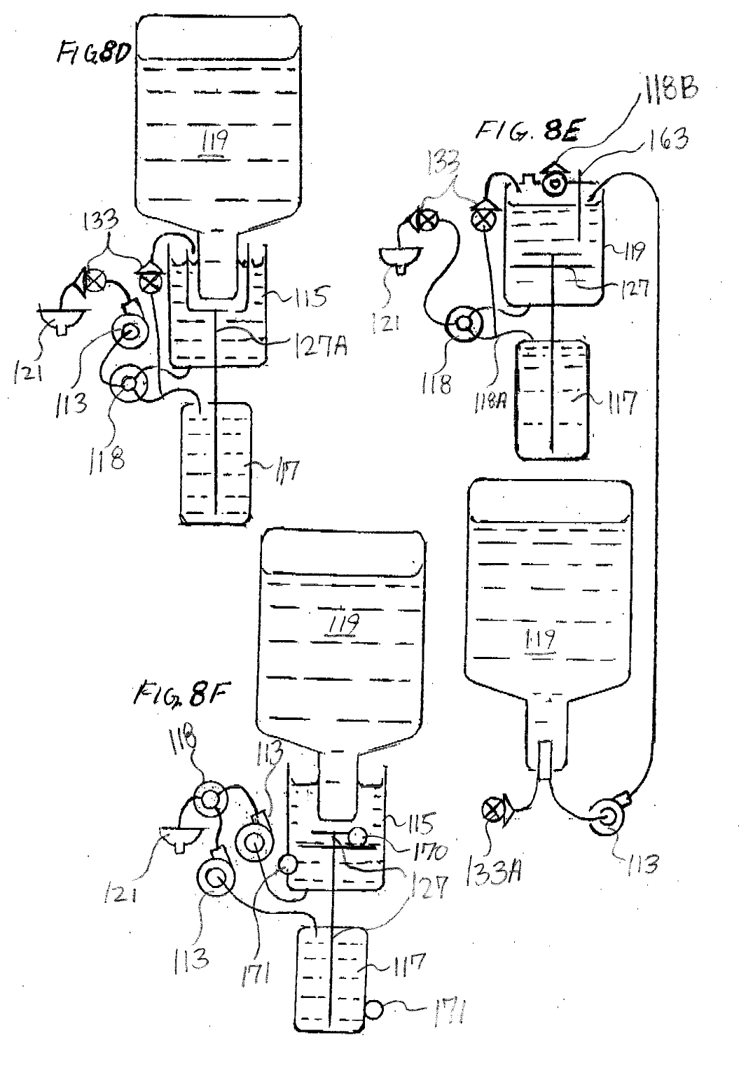

Referring back to FIG. 1, electronic sensor 135 may be used to sense the presence of a water bottle 119, turning the pump on. If sensor 135 does not sense a water bottle, dispensing may not be permitted. Sensor 135, or a different sensor 163 in FIG. 8E may also be used to sense the water level in the cold and hot tanks, and turn on the water pump to fill the tanks, if necessary. A quick-connect device, such as a John Guest® Pipe-to-Pipe connector (http://www.johnguest.com/part_spec.asp?s=PEM04_S1) may be used to enable efficient replacement of the pump.

Referring now to FIGS. 8A-8F, various alternative dispensing apparatus constituting closed, pressurized systems (with the exception of FIG. 8E, discussed below) are shown, which may be used in the context of the present invention. Referring first to FIG. 8A, water flows from water bottle 119 into cold tank 115 and through baffle 127. Baffle 127 may consist, for example, of a 2-piece assembly (2 T-shapes, in sideview, joined together) inserted onto/into the cold tank feeding tube opening to the hot tank area. The purpose of this baffle is to prevent the boil-back hot water from affecting the cold dispensing-ready water temperature and vise versa. Accordingly, the boil-back hot water may be permitted to pass through the lower T hollow center tube of the baffle and enter to the cold tank. Since hot water has lower density than cold water, the hot water will tend to stay above the baffle area. Water flow may be controlled by water pump 113, 3-way solenoid 118 and check valve 133, and water may be eventually dispensed through dispensing spout 121. The water dispensing system shown in FIG. 8B is similar to that shown in FIG. 8A, except that a check valve 133 has been added between the effluent from the hot tank and an intake to the cold tank, to prevent air draw-back. T-connector 118A may be used to provide a venting path for steam from the hot tank. Referring to FIG. 8C, the system shown there is similar to the system shown in FIG. 8B, except that the baffle has been replaced with a reservoir 149; water from the water bottle may now flow directly into reservoir 149, and then directly into either the cold tank or the hot tank. Referring to FIG. 8D, the system shown is similar to the system shown in FIG. 8B, except that a new baffle 127A may be employed which physically separates the room temperature water/boil-back hot water from the cold water, to render the system more efficient.

Referring now to FIG. 8E, a water system with a different configuration is shown: a bottom load water path, which may be employed with the Bottom Load Water Cooler Invention, in which (e.g.) cold and hot tanks may be positioned above the water bottle. Here, water pump 113 has been relocated so that water is pumped upwardly from the water bottle into cold tank 115; water may then travel through baffle 127 and into hot tank 117 under control of the water pump and solenoids 118 and 118A. Solenoid valve 118B may be normally open, to render the cold tank an open system. Liquid level sensor 163 may be used to sense the water level in the cold tank and shut off the pump when the desired water level is reached. Pressure relief check valves 133 may be used in case of over-pressure in the system (such as due to boiling water in the hot tank), while a breathing check valve 133A may be used adjacent the bottle neck to ensure ambient air enters the bottle to prevent lock-up during dispensing. When the user depresses the water dispensing button or tab, the PCB transmits a signal to close solenoid valve 118B, rendering the system closed. 3-way solenoid 118A opens the corresponding opening and water pump 113 begins pumping water. When the user releases the water dispensing button, the PCB transmits a signal to open solenoid valve 118B and again make the system an open system, and the water pump will stop pumping.

Referring to FIG. 8F, yet another alternative dispensing system and liquid flow path is disclosed. Here, one 3-way solenoid valve 118 (or, alternatively, two 2-way solenoid valves, not shown) may be used to control liquid flow. Two pumps 113 may be used: one to dispense cold water, and one to dispense hot water. A baffle 127 may again be used for both tanks. Temperature sensors 171 may be used for both hot and cold tanks. An insta-boil sensor 170 may be used in the cold tank. A hot side solenoid valve (not shown) may be opened, if necessary, to allow air trapped in the hot tank to escape; alternatively, the emergency valve system shown in FIG. 8E, or the emergency valve and reservoir system shown in FIG. 9 of the Bottom Load Water Cooler Invention, may be used to ensure an over-pressure situation does not occur from boiling the water in the hot tank.

The above description is not intended to limit the meaning of the words used in the following claims that define the invention. Other systems, methods, features, and advantages of the present invention will be, or will become, apparent to one having ordinary skill in the art upon examination of the foregoing drawings, written description and claims, and persons of ordinary skill in the art will understand that a variety of other designs still failing within the scope of the following claims may be envisioned and used. For example, consumable liquids other than water, such as but not limited to carbonated beverages, may be dispensed. It is contemplated that these or other future modifications in structure, function or result will exist that are not substantial changes and that all such insubstantial changes in what is claimed are intended to be covered by the claims.

The following terms are used in the claims of the patent as filed and are intended to have their broadest meaning consistent with the requirements of law. Where alternative meanings are possible, the broadest meaning is intended. All words used in the claims are intended to be used in the normal, customary usage of grammar and the English language.

We claim:

1. A liquid dispensing system, comprising:
a renewable source of the liquid in fluid communication with a liquid reservoir, wherein liquid moving from the renewable source to the liquid reservoir defines a liquid flow path;
an engagement device in fluid communication with the reservoir for removably engaging the renewable source in fluid communication, the engagement device housing separate conduits respectively defining a portion of the liquid flow path, and also defining a separate air flow path through the engagement device and into the renewable source.

2. The liquid dispensing system of claim 1, wherein the renewable source comprises a water bottle.

3. The liquid dispensing system of claim 1, further comprising a pump in fluid communication with the renewable source of the liquid and with the liquid reservoir.

4. The liquid dispensing system of claim 1, wherein the liquid reservoir comprises separate cold and hot tanks in fluid communication with each other.

5. The liquid dispensing system of claim 1, wherein ambient air from the atmosphere supplies air to the air flow path of the engagement device.

6. The liquid dispensing system of claim 5, further comprising a check valve for controlling the intake of the ambient air to the engagement device.

7. The liquid dispensing system of claim 1, wherein the liquid reservoir includes a device for air-tight sealing of the reservoir when liquid in the reservoir has reached a desired level.

8. The liquid dispensing system of claim 7, wherein the device for air-tight sealing of the reservoir comprises a floating ball designed to seat against an opening in the liquid reservoir once the liquid reservoir contains a certain volume of liquid, the opening otherwise communicating with ambient air.

9. The liquid dispensing system of claim 1, further comprising a computer in communication with the liquid reservoir and a pump.

10. The liquid dispensing system of claim 9, further comprising a solenoid in communication with the liquid reservoir and with the computer.

11. The liquid dispensing system of claim 1, further comprising a sensor for sensing the presence of the renewable source of liquid.

12. The liquid dispensing system of claim 1, further comprising a sensor for sensing the liquid level in the renewable source.

13. The liquid dispensing system of claim 1, further comprising a bottle cap including:
a cap body comprising an outer annular wall sized to sealingly contact a neck of the liquid reservoir, and an inner annular wall with at least one plug gripping formation; and
a cap plug having an outer surface with at least one cap gripping formation for engaging a corresponding of the at least one plug gripping formation;
wherein the cap body and the cap plug are physically attached by a tether to ensure that the cap plug does not completely disassociate from the cap during liquid reservoir removal and replacement.
